(19) United States
(12) Patent Application Publication
(10) Pub. No.: US 2013/0028649 A1
(43) Pub. Date: Jan. 31, 2013

(54) TUBULAR CASE

(71) Applicant: Shogo Kobayashi, Osaka (JP)

(72) Inventor: Shogo Kobayashi, Osaka (JP)

(73) Assignee: KOKUYO CO., LTD., Osaka-shi, Osaka (JP)

(21) Appl. No.: 13/639,286

(22) PCT Filed: May 31, 2010
(86) PCT No.: PCT/JP2010/059195

§ 371 Date: Oct. 4, 2012

(51) Int. Cl. B43M 11/06

(52) U.S. Cl. 401/61

(57) ABSTRACT

There is provided a tubular case that can selectively perform coupling release operation of a cap, and removal operation of a refill case using a common operating member. A tubular case 10 includes a case 15 including a refill case 13 for supporting an item to be received in an advanceable and retractable manner with respect to a case body 11, a cap 18 for closing an opening 40 of the case 15, and an operating member 20 mounted on the outer periphery side of the case body 11. The operating member 20 is configured to selectively perform coupling release of the cap 18 and removal of the refill case 13 by rotational operation about the predetermine center of rotation.

### FIELD OF THE INVENTION

The present invention relates to a tubular case that receives, for example, a stick of solid glue, which is an item to be received, in an advanceable and retractable manner through an opening of the case, and more particular, a tubular case that can selectively perform coupling release of a cap mounted on a case, and removal of a refill case receiving an item to be received, by using a common operating member.

### BACKGROUND OF THE ART

Conventionally, there is known a tubular case having a cylindrical shape in appearance, the tubular case receiving a stick of solid glue, which is an item to be received, such that the solid glue can be advanced and retracted through an opening formed in one end of the case. The tubular case is provided with a cap covering the opening of the case, the cap configured to engage with an outer periphery on the opening side of the case.

The cap of this kind can be prevented from accidental falling-off from the case by using a structure for engagement with the case. However, since the cap has a relatively short cylindrical shape relative to the entire length of the tubular case, the cap has disadvantage such that fingers are slippery while releasing the cap from the coupling, which causes a burdensome operation in removing the cap.

To solve the above problem, the applicant proposed a tubular case that allows easy removal of a cap from a case by releasing coupling of the cap to the case.

### PRIOR ART DOCUMENT

Patent Document 1 Japanese Patent Application Laid-Open No. 2007-261592

### SUMMARY OF THE INVENTION

### Problem to be Solved by the Invention

The tubular case disclosed in Patent Document 1 is configured such that the cap can be easily released from coupling by exerting an operating force on an operating member, and a case body and a refill case (a cartridge) can be disengaged to remove the refill case by pressing-operation of a pressing member provided in an outer peripheral (peripheral wall) portion of the case.

However, the tubular case disclosed in Patent Document 1 requires the operating member and the pressing member to perform coupling release of the cap and removal of the refill case. This results in disadvantage in that the arrangement is complicated, and moreover there are different operation locations between the case of the coupling release of the cap and the case of the removal of the refill case. Therefore, from the point of view of usability, there is slight room for improvement.

### Object of the Invention

An object of the present invention is to provide a tubular case that can selectively perform, using a common operating member, coupling release operation of a cap coupled on the opening side of a case, and removal operation of a refill case received in a case body.

Another object of the present invention is to provide a tubular case that can prohibit the operation of the operating member as needed.

### Means for Solving Problems

To achieve the object, the present invention adopts an arrangement defined by claims. In particular, the present invention adopts the following arrangement: a tubular case comprises a case including a case body having an opening at one end thereof, and a refill case for supporting an item to be received in an advanceable and retractable manner with respect to the case body, a cap provided to be coupled to the case to close the opening, and an operating member mounted on the outer periphery side of the case body,

wherein the operating member is configured to selectively perform coupling release of the cap, and removal of the refill case by carrying out a predetermined operation.

The present invention adopts the following arrangement: the operating member includes an annular body supported rotatably about two points, which are the center of rotation, on an imaginary straight line crossing an axial direction of the case body,

rotational operation in one direction of the operating member enables the cap to be released from coupling, whereas rotational operation in the counter direction enables removal of the refill case.

Preferably, such an arrangement is adopted that the operating member is provided on a closed loop shape surrounding an outer peripheral surface of the case body.

Also, the present invention adopts the following arrangement: the tubular case further comprises a locking member for prohibiting operation of the operating member.

The present invention adopts the following arrangement: the locking member has a ring shape provided on the outer periphery side of the case body and under the operating member, and provided rotatably along a circumferential direction of the case body so as to be capable of being selectively stopped at each of positions including an operation prohibition position of the operating member, a coupling release permission position of the cap, and a removal operation permission position of the refill case.

The present invention may adopt the following arrangement: the locking member comprises an inclined portion within a predetermined angular range along the circumferential direction, and the operation prohibition position, the coupling release permission position, and the removal operation permission position are selected by changing the position of the inclined portion along an outer peripheral of the case body.

Also, the present invention, preferably, adopts the following arrangement: a rotatable operating portion of the locking member integrally protrudes on the opposite side of the inclined portion.

### Effect of the Invention

According to the present invention, the coupling release of the cap and the removal operation of the refill case can selectively be performed by common use of the single operating member.

Also, since either the coupling release of the cap or the removal of the refill case can be performed only by rotating the operating member either in one direction or in the counter direction, the convenience of the operation can be provided.

Further, the operating member having the closed loop shape enables the strength of the operating member to be increased, and the operating member to be prevented from dropping off from the case body.

Moreover, an adopted arrangement including the locking member can prevent the possibility of release of the cap from coupling and ejection of the refill case from the case body, even if an unexpected operating force is applied to the operating member.

Furthermore, by holding the ring member in a predetermined position along the circumferential direction of the case body, the operation prohibition position, the coupling release permission position, and the removal operation permission position can be selected.

Further, in an arrangement in which the inclined portion is formed in the locking member, since a user only has to select the position of the inclined portion from the above positions, it is possible to visually identify the position of the locking member, and provide, using a simple arrangement, an aspect in which the permission and the prohibition of operation of the operating member can be easily selected.

Furthermore, in an arrangement of the rotatable operating portion protruding on the opposite side of the inclined portion, it is facilitated to apply an operating force to the rotatable operating portion.

### BRIEF DESCRIPTION OF THE DRAWINGS

FIG. 1 is a schematic front view showing the entire arrangement of a tubular case according to the embodiment;

FIG. 2 is a vertical cross-sectional view of the tubular case;

FIG. 3(A) is a plan view of a case body, and FIG. 3(B) is a front view of the case body;

FIG. 4(A) is a cross-sectional view taken along the line A-A in FIG. 3(A), and FIG. 4(B) is a cross-sectional view taken along the line B-B in FIG. 3(A);

FIG. 5(A) is a plan view of a refill case, FIG. 5(B) is a front view of the refill case, and FIG. 5(C) is a bottom view of the refill case;

FIG. 6(A) is a cross-sectional view taken along the line A-A in FIG. 5(A), and FIG. 5(B) is a cross-sectional view taken along the line B-B in FIG. 5(A);

FIG. 7 is a front view with a shaft member partially cut into a cross-section;

FIG. 8 is a cross-sectional view of an up/down movement member supporting solid glue;

FIG. 9(A) is a front view of an operating knob, and FIG. 9(B) is a vertical cross-sectional view of the operating knob;

FIG. 10(A) is a front view of a cap, and FIG. 10(B) is a vertical cross-sectional view of the cap;

FIG. 11(A) is a plan view of an operating member, FIG. 11(B) is a front view of the operating member, FIG. 11(C) is a vertical cross-sectional view of the operating member, and FIG. 11(D) is a bottom view of the operating member;

FIG. 12(A) is a plan view of a locking member, FIG. 11(B) is a front view of the locking member, FIG. 11(C) is a left side view of FIG. 12(B), FIG. 11(D) is a right side view of FIG. 12(B), FIG. 11(E) is a vertical cross-sectional view of the locking member, and FIG. 11(F) is a bottom view of the locking member;

FIG. 13 is an explanatory view illustrating a state that the refill case is removed by the operating member;

FIG. 14 is an explanatory view illustrating a state that the locking member is at the coupling release permission position of the cap;

FIG. 15 is an explanatory view illustrating a state that the cap has been released from the coupling by the operating member; and

FIG. 16 is an explanatory view illustrating a state that the operating member is prevented from being operated using the locking member.

### EXPLANATION OF REFERENCE NUMERALS

10 tubular case
11 case body
12 solid glue (item to be received)
13 refill case
15 case
18 cap
20 operating member
21 locking member
40 opening
80 annular body
90 inclined portion
91 rotatable operating portion

### DESCRIPTION OF THE PREFERRED EMBODIMENT

An embodiment in which the present invention is applied to a tubular case with a stick of solid glue which is an item to be received will now be described below with reference to drawings.

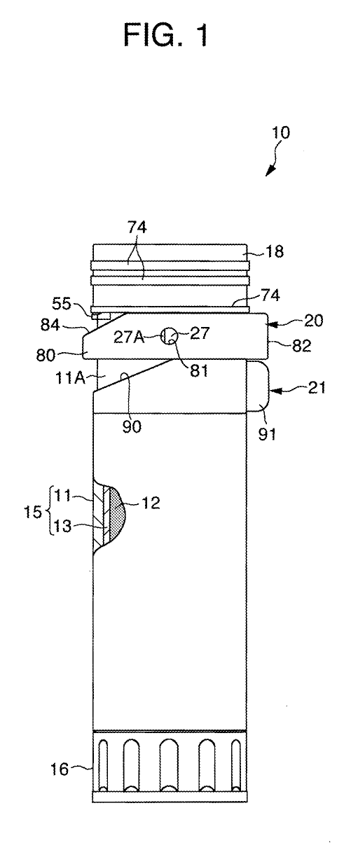

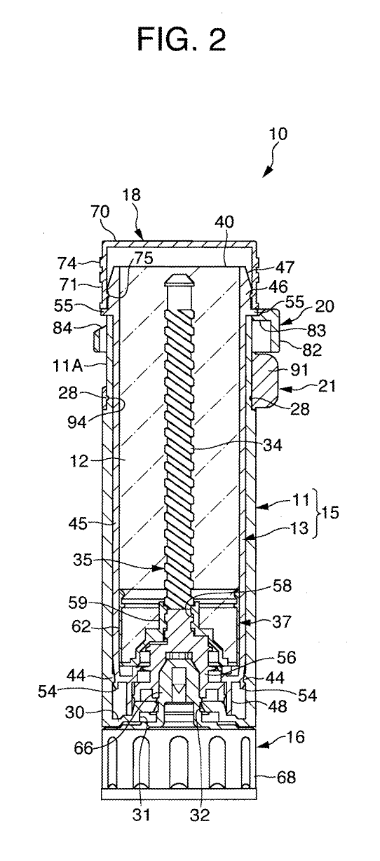

As shown in FIGS. 1 and 2, a tubular case 10 according to the embodiment comprises: a case 15 including a case body 11, and a refill case 13 received in the case body 11 and for supporting a stick of solid glue 12 which is an item to be received; an operating knob 16 rotatably attached to a lower end portion of the case 15 in figures; a cap 18 provided to be coupled to the upper outer periphery side of the case 15; an operating member 20 selectively allowing for coupling release of the cap 18 and removal of the refill case 13; and a locking member 21 provided on the outer periphery side of the case 11 and under the operating member 20.

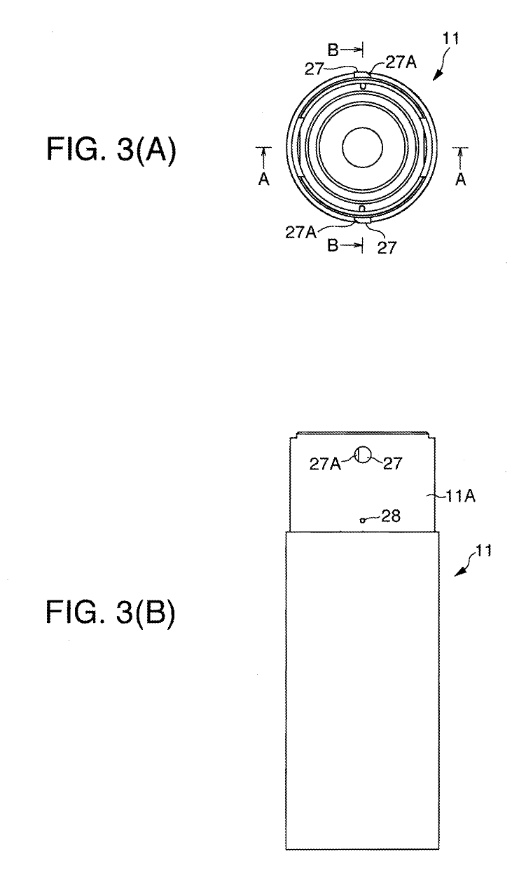

The case body 11, as shown in FIGS. 2 and 3, has a substantially cylindrical shape. A specified region on the upper end side of the case body 11 along an axial direction (vertical direction) is formed as a mounting area 11A for the operating member 20, the specified region having the dimension of the outer diameter slightly smaller than that of the other region. Protruding shafts 27, which form the center of rotation of the operating member 20, are formed at locations spaced substantially 180 degrees apart along the outer peripheral of the mounting area 11A, i.e. at two points on an imaginary straight line crossing an axial direction of the case 15. Each of the protruding shafts 27 has an inclined face 27A that is inclined in a partial region of the tip thereof with respect to the axis of the protruding shaft 27. When the operating member 20, which is positioned around the mounting area 11A, is rotated in a plane, the inclined face 27A facilitates easy coupling of the protruding shafts 27 into bearing holes of the operating member 20 as described below. Moreover, in the mounting area 11A, recesses 28 for holding the rotational position in a plane of the locking member 21 are formed spaced at 90 degree intervals in a circumference direction of the case body 11 under the protruding shafts 27.

A bottom portion 30 of the case body 11 has a shape having a hole 32 passing through the bottom portion 30 in a vertical direction via a step portion 31. With passing through the hole 32, a rotary member 35 having a screw shaft 34 extending in the solid glue 12 is arranged. The operating knob 16 arranged under the bottom portion 30 engages with a lower part of the rotary member 35. An up/down movement member 37 for supporting a lower portion of the solid glue 12 is relatively rotatably arranged on the outer periphery side of the rotary member 35. Upward and downward movement of the up/down movement member 37 allows the solid glue 12 to freely advance and retract through an opening 40 located in an upper end of the case 15.

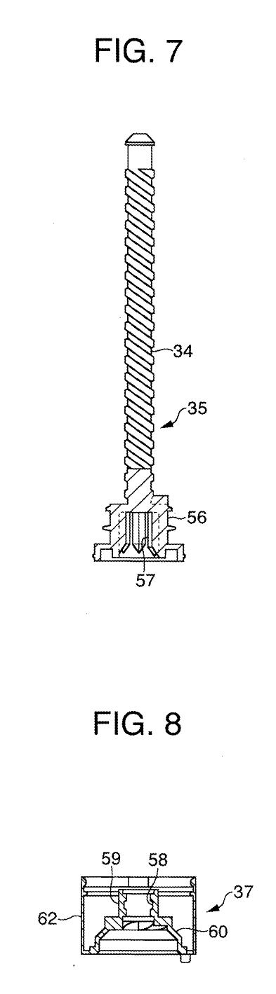

The rotary member 35, as shown in FIG. 7, includes a skirt portion 56 whose the outer diameter on the lower end side thereof is increased in two steps. Grooves 57 are spaced at predetermined intervals in a circumferential direction on the inner periphery side of the skirt portion 56. Moreover, the up/down movement member 37, as shown in FIG. 8, comprises an inner cylinder 59 provided with a female screw portion 58 which engages with the screw shaft 34, and an outer cylinder 62 continuing to a lower portion of the inner cylinder 59 via a taper portion 60.

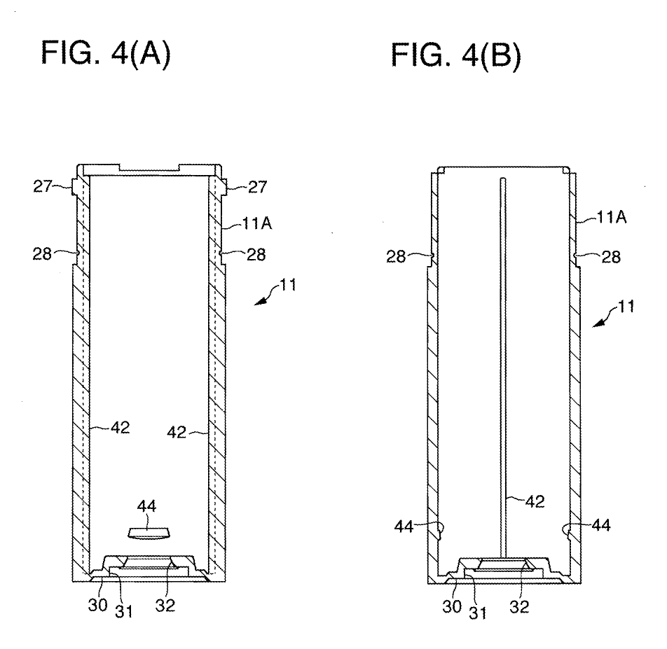

An inner periphery on the case body 11, as shown in FIG. 4, has vertical ribs 42 in 180 degrees symmetrical positions in a circumferential direction, and is provided with protruding portions 44, located in a lower area of the positions shifted by 90 degrees in a circumferential direction with respect to the vertical ribs 42, for holding the position of the refill case 13 by engaging with a lower portion of the refill case 13.

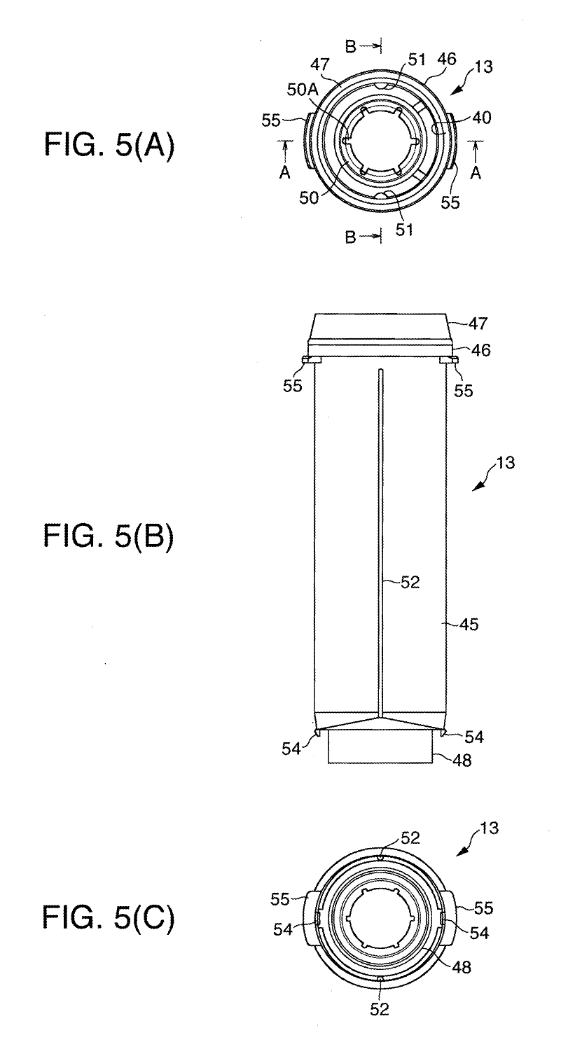

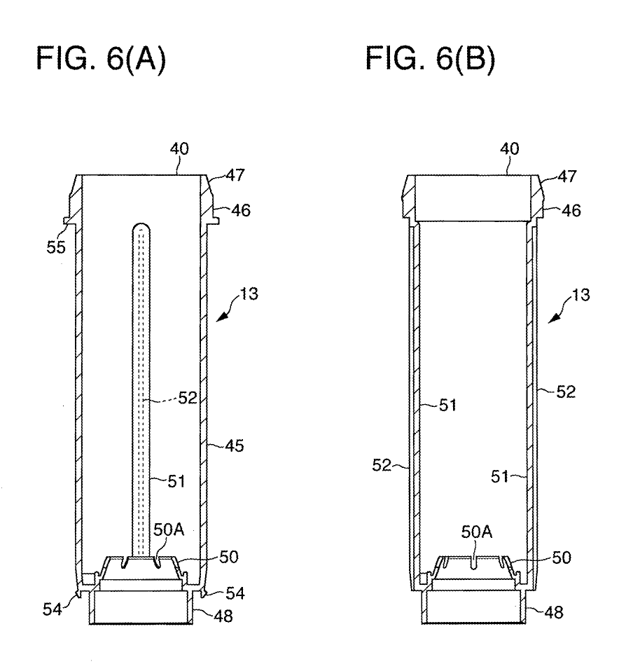

The refill case 13, as also shown in FIGS. 5 and 6, comprises a cylindrical refill body 45 having the opening 40 in an upper end thereof, a large diameter portion 46 provided on the upper end side of the refill body 45, a tapered tip portion 47 located above the large diameter portion 46, and a small diameter portion 48 continuously provided in a lower end of the refill body 45. A taper cylinder shaped portion 50 having slits 50A in an upper end portion is continuously provided above the small diameter portion 48. Concave-shaped portions 51 extending in the vertical direction are formed in an inner periphery of the refill case 13, each being at a 180 degrees symmetrical position in a radial direction. Concave grooves 52 are formed on the outer surface side of the concave-shaped portion 51, the concave grooves 52 receiving the vertical ribs 42 therein provided in the inner periphery of the case body 11. Thus, with the refill case 13 being received in the case body 11, the case body 11 and the refill case 13 are prevented from relatively moving in a circumferential direction, while permitted to relatively move in an axial direction.

At a position shifted by 90 degrees in a circumferential direction with respect to the concave groove 52, hooking members 54 are provided in a lower end portion of the refill body 45. The hooking members 54 are engageable with the protruding portions 44 provided in the inner periphery of the case body 11.

Moreover, above the hooking members 54 and directly below the large diameter portion 45, protruding pieces 55 which projecting in a plane are provided at 180 degrees symmetrical positions in a circumferential direction.

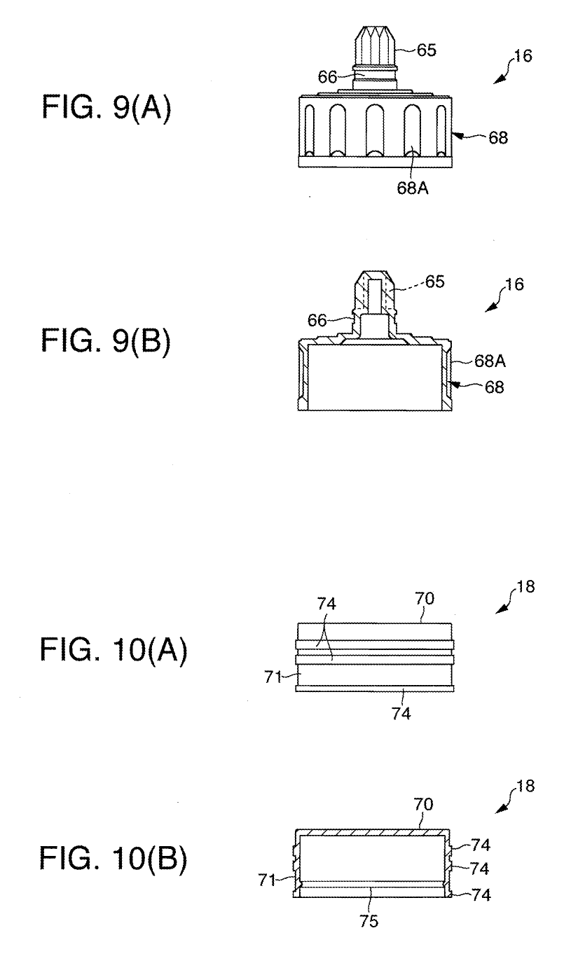

The operating knob 16, as shown in FIG. 9, includes a cylindrical shaft 66 an outer periphery of which has a teeth portion 65 which engages with the grooves 57 provided in the inner periphery of the skirt portion 56 of the rotary member 35, and a lower-end opened knob cylinder 68 continuing to a lower end of the cylindrical shaft 66. The knob cylinder 68 has an antislip concave portion 68A on an outer periphery thereof.

The cap 18, as shown in FIG. 10, includes a top wall 70, and a cylindrical portion 71 located on the outer periphery side of the top wall 70. Ribs 74 extending in the circumferential direction are formed at intermediate positions of an outer periphery and at a lower end position of the cylindrical portion 71. Moreover, an inner convex portion 75 extending in the circumferential direction is formed on an inner periphery side of the cylindrical portion 71. The inner convex portion 75 is provided capable of coupling to the upper large diameter portion 46 of the refill case 13 with a click action.

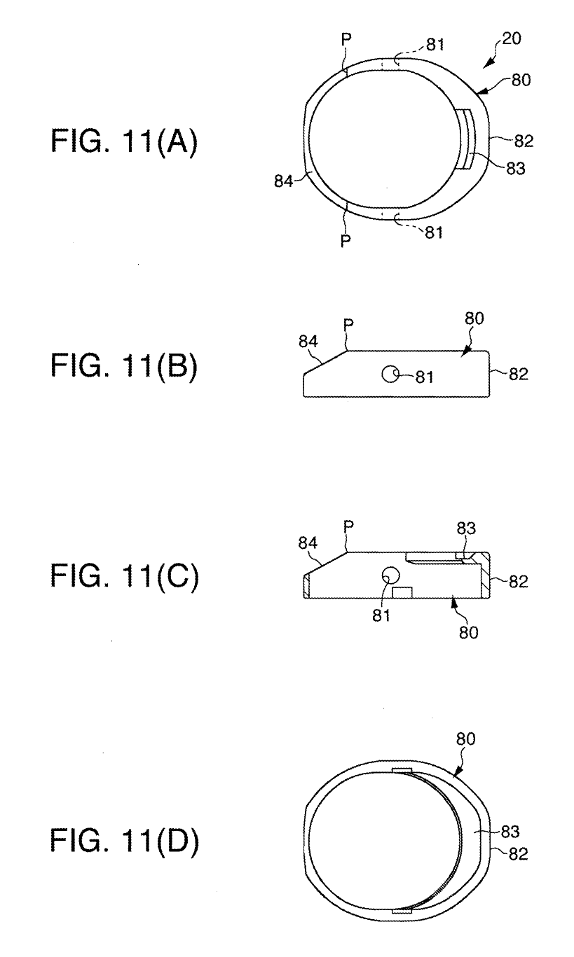

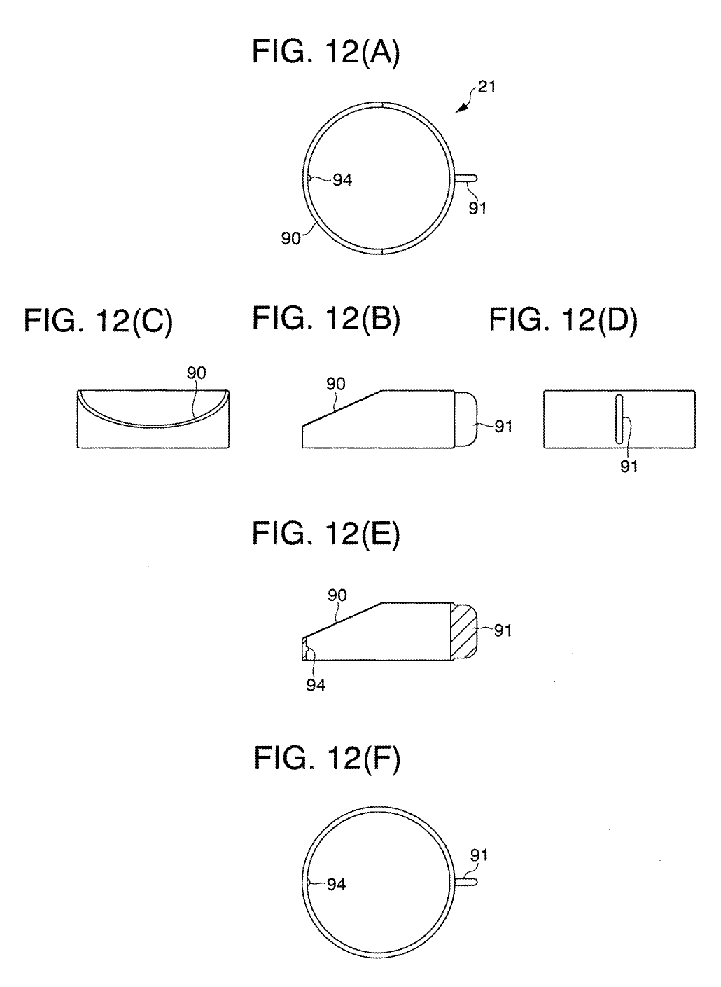

The operating member 20 is configured to selectively perform coupling release of the cap 18 by rotational operation in one direction, and removal of the refill case 13 by rotational operation in the counter direction. The operating member 20, as shown in FIG. 11, is supported rotatably about the protruding shafts 27 located at two points, which are the center of rotation, on an imaginary straight line crossing the axial direction of the case body 11, and includes a closed-loop shaped annular body 80 surrounding an outer peripheral surface of the case body 11. The annular body 80 has an outer diameter approximate to an ellipse in planar view, and comprises, in both sides in the minor axis direction, bearing holes 81 receiving the protruding shafts 27. An operating force imparting portion 82 is formed on the one end side in a direction perpendicular to an imaginary straight line connecting these bearing holes 81 in a plane. A step-down portion 83 extending out to the inner periphery side is formed in the operating force imparting portion 82, such that a protruding piece 55 of the refill case 13 is seated on the upper surface side of the step-down portion 83. Moreover, on the opposite side of the operating force imparting portion 82, there is formed an inclined upper edge portion 84 inclined such that the height of an upper end thereof is gradually reduced. The location of a right end (in FIG. 11 (A)) of the inclined upper edge portion 84 constitutes a pair of force-applying point portions P by which exerts a force in releasing coupling of the cap 18.

The locking member 21 has a ring shape provided on the outer periphery side of the case body 11 and under the operating member 20. The locking member 21 is provided rotatably along a circumferential direction of the case body 11, with having ability to selectively stop at each of positions including an operation prohibition position of the operating member 20, a coupling release permission position of the cap 18, and a removal operation permission position of the refill case 13. In more particular, the locking member 21 has a shape generally similar to an outer shape of the operating member 20. On the upper edge side, the locking member 21 includes an inclined portion 90, the height of an upper end of which is gradually decreased within a certain angular range along a circumferential direction. On the opposite side, the locking member 21 is integrally provided with a rotatable operating portion 91 of the locking member 21. In this arrangement, the length of the inclined portion 90 in front view is designed to be longer than that of the inclined upper edge portion 84 of the operating member. Also, the rotatable operating portion 91 has a piece-like shape, and protrudes in a state that a face of the rotatable operating portion 91 is in a vertical plane. A projection 94 is provided in a portion of an inner periphery surface of the locking member 21 located on the opposite side to the rotatable operating portion 91. The projection 94 is provided to be engageable with any recess 28 formed in the mounting area 11A of the case body 11 with a click action such that the projection 94 can keep a stationary position at each predetermined angle, in the embodiment, at each 90 degrees in a circumferential direction of the outer periphery of the case body 11.

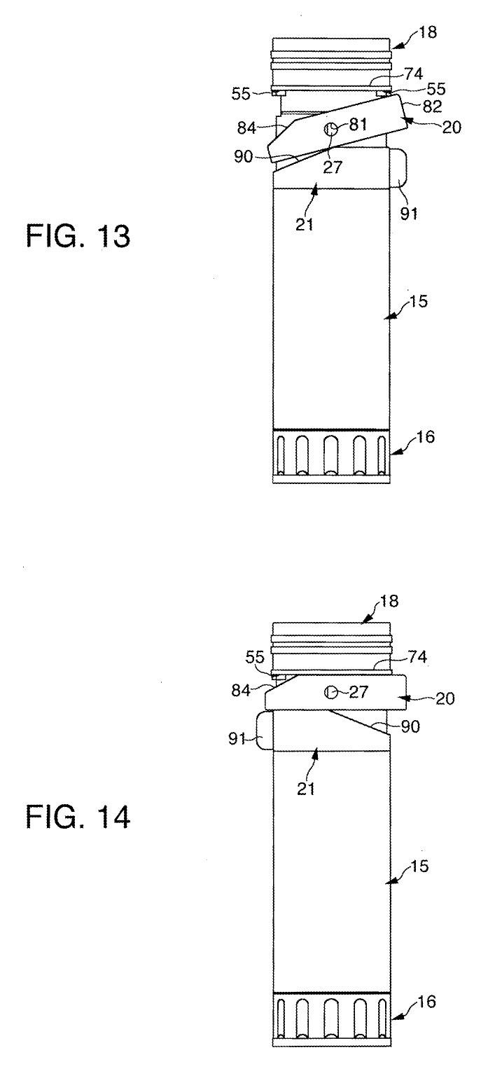

Next, an assembling method of the tubular case 10 in the embodiment is described, and then a procedure for coupling release of the cap 18 and removal of the refill case 13 will be described with reference to FIGS. 13 to 16.

In assembling the tubular case 10, the shaft 66 of the operating knob 16 is inserted into the hole 32 formed in the bottom portion 30 of the case body 11. Moreover, the locking member 21 and the operating member 20 are mounted in this order on the upper mounting area 11A from the upper end of the case body 11 to combine them with the case body 11.

On the other hand, while the stick of solid glue 12 is supported by the up/down movement member 37, the rotary member 35 is screwed into the inner cylinder 59 of the up/down movement member 37 to pass through it so that the rotary member 35 is received within the refill case 13.

Then, after the refill case 13 is received in the case body 11 and the cap 18 is mounted, the assembly of the tubular case 10 can be completed. In this case, as shown in FIG. 16, the locking member 21 is initially set such that the rotatable operating portion 91 is positioned directly below the bearing hole 81 of the operating member 20. Thus, the operating member 20 is in a relative position at which a lower end edge on the operating force imparting portion 82 side and a lower end edge on the opposite side of the operating force imparting portion 82 are in contact with an upper edge of the locking member 21 except the inclined portion 90 thereof. Therefore, the operating member 20 is prevented from being rotated about the axis of the protruding shafts 27, and held in an operation prohibition position in which coupling release of the cap 18 and removal operation of the refill case 13 are prohibited. In this case, the locking member 21 is in a condition in which the projection 94 provided in the inner periphery surface is coupled in a recess 28 of the case body 11, and does not rotate in a plane unless an operating force is exerted.

When the refill case 13 is removed from the case body 11 after the solid glue 12 has been consumed, as shown in FIG. 13, the operating force imparting portion 91 of the locking member 21 may be rotated 90 degrees in a plane by picking up it to set to the removal operation permission position. At this time, the projection 94 can be stopped by coupling with the recess 28 positioned at a location shifted by 90 degrees along a circumferential direction of the case body 11, and a user can recognize the stop position of the locking member 21 due to obtaining a click feeling.

In this way, when the position of the locking member 21 is rotated, the inclined portion 90 of the locking member 21 is in a corresponding position under the inclined upper edge portion 84 of the operating member 20. Then, by exerting an operating force so as to push up the operating force imparting portion 82 upward, since engagement of the protruding piece 55 of the refill case 13 in such a way that the protruding piece 55 of the refill case 13 seats on the step-down portion 83 of the operating member 20, the refill case 13 is pushed up upward, while the engagement between the lower hooking members 54 and the protruding portions 44 of the inner periphery surface of the body case 11 is released so that the refill case 13 relatively projects from the top of the body case 11. Therefore, the refill case 13 and the up/down movement member 37 and the rotary member 35 which are combined with the refill case 13 can be integrally removed by picking up the projected portion with fingers and pulling it out. Thus, another refill case 13 can be received into the body case 11 again.

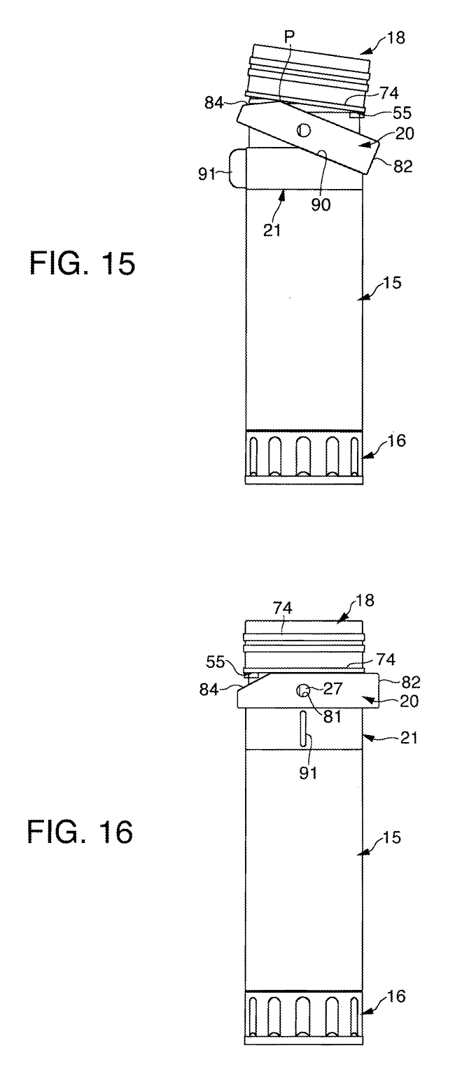

In the case of using the solid glue 12, i.e., of releasing the coupling of the cap 18 without removing the refill case 13, as shown in FIG. 14, the locking member 21 may be set to the coupling release permission position by rotating it 180 degrees with respect to the position shown in FIG. 13. This allows the inclined portion 90 to be positioned on the operating force imparting portion 82 side of the operating member 20. Thus, as shown in FIG. 15, when the operating force imparting portion 82 is rotated by pressing down it downward, force-applying points P on the upper level side of the inclined upper edge portion 84 are brought into contact with the rib 74 of the cap 18 at two sites to push up the rib 74 from below, while the rib 74 is placed on the protruding piece 55, and thereby this create a pivot point, thus releasing the coupling between the cap 18 and the large diameter portion 46 of the refill case 13. Therefore, the cap 18 can be removed.

Therefore, according to this embodiment, such advantage is obtained that coupling release of the cap 18 and removal of the refill case 13 can be selectively performed in a situation of common use of the single operating member 20.

Also, such convenience can be provided that the locking member 21 provided enables the prohibition of unintended coupling release of the cap and removal of the refill case 13, while the operation for canceling such prohibition can also be performed only by rotational operation of the locking member 21.

The best arrangement, method, item to be received, and the like for carrying out the present invention have been disclosed, and however, the present invention is not limited to the above.

That is, the present invention has been illustrated and described mainly about a specific embodiment. However, those skilled in the art can add various modifications to the above-described embodiment with respect to the shape, position and/or other detailed arrangements without departing from the technical spirit and the range of the object of the present invention.

Thus, the above descriptions defining shapes, positions and the like are given as examples for facilitating understanding the present invention but not intended to limit the present invention. Therefore, any descriptions using appellations of articles precluding a part/all of the limitations such as the shapes and the like should be understood to be included within the present invention.

In the above-mentioned embodiment, for example, the case where the operating member 20 is provided together with the locking member 21 has been described and illustrated. However, the present invention does not exclude a tubular case without the locking member 21. Moreover, an arrangement for prohibiting operation of the operating member 20 is not limited to the locking member 21 as illustrated, and may perform the operation of prohibition of the operating member and the release thereof by moving the locking member 21 itself relative to the case body 15, by changing the position of the operating member 20 itself, and so on.

Also, in order to hold the refill case 13 in a predetermined location within the case body 11, such an arrangement that the hooking members 54 are provided in the lower portion of the refill case 13 and the hooking members 54 engage with protruding portions 44 of the body case 11 has been illustrated and described. However, the present invention is not limited to it, but may be configured such that a suitable convex portion is formed in the upper outer peripheral of the refill case 13, and a concave portion to be coupled to the convex portion is formed in a portion of the inner periphery surface of the case body 11.

Furthermore, although the operating member 20 has been formed into the closed-loop shaped annular body 80, the annular body 80 may be C-shaped with a portion of the annular body 80 cut off.

Moreover, the item to be received is not limited to the solid glue 12, but may be cosmetics and the like.

### FIELD OF INDUSTRIAL APPLICATION

The present invention may be applied to, e.g., tubular cases that can advance and retract a stick of solid glue, and the like.

1. A tubular case, comprising: a case including a case body having an opening at one end thereof, and a refill case for supporting an item to be received in an advanceable and retractable manner with respect to the case body; a cap provided to be coupled to the case to close the opening; and an operating member mounted on the outer periphery side of the case body,
wherein the operating member is configured to selectively perform coupling release of the cap, and removal of the refill case.

2. The tubular case according to claim 1, wherein
the operating member includes an annular body supported rotatably about two points, which are the center of rotation, on an imaginary straight line crossing an axial direction of the case body,
rotational operation in one direction of the operating member enables the cap to be released from coupling, whereas rotational operation in the counter direction enables removal of the refill case.

3. The tubular case according to claim 1, wherein the operating member is provided on a closed loop shape surrounding an outer peripheral surface of the case body.

4. The tubular case according to claim 1, further comprising a locking member for prohibiting operation of the operating member.

5. The tubular case according to claim 2, further comprising a locking member for prohibiting operation of the operating member.

6. The tubular case according to claim 3, further comprising a locking member for prohibiting operation of the operating member.

7. The tubular case according to claim 4, wherein the locking member has a ring shape provided on the outer periphery side of the case body and under the operating member, and provided rotatably along a circumferential direction of the case body so as to be capable of being selectively stopped at each of positions including an operation prohibition position of the operating member, a coupling release permission position of the cap, and a removal operation permission position of the refill case.

8. The tubular case according to claim 5, wherein the locking member has a ring shape provided on the outer periphery side of the case body and under the operating member, and provided rotatably along a circumferential direction of the case body so as to be capable of being selectively stopped at each of positions including an operation prohibition position of the operating member, a coupling release permission position of the cap, and a removal operation permission position of the refill case.

9. The tubular case according to claim 6, wherein the locking member has a ring shape provided on the outer periphery side of the case body and under the operating member, and provided rotatably along a circumferential direction of the case body so as to be capable of being selectively stopped at each of positions including an operation prohibition position of the operating member, a coupling release permission position of the cap, and a removal operation permission position of the refill case.

10. The tubular case according to claim 7, wherein the locking member comprises an inclined portion within a predetermined angular range along the circumferential direction, and the operation prohibition position, the coupling release permission position, and the removal operation permission position are selected by changing the position of the inclined portion along an outer peripheral of the case body.

11. The tubular case according to claim 8, wherein the locking member comprises an inclined portion within a predetermined angular range along the circumferential direction, and the operation prohibition position, the coupling release permission position, and the removal operation permission position are selected by changing the position of the inclined portion along an outer peripheral of the case body.

12. The tubular case according to claim 9, wherein the locking member comprises an inclined portion within a predetermined angular range along the circumferential direction, and the operation prohibition position, the coupling release permission position, and the removal operation permission position are selected by changing the position of the inclined portion along an outer peripheral of the case body.

13. The tubular case according to claim 10, wherein a rotatable operating portion of the locking member integrally protrudes on the opposite side of the inclined portion.

14. The tubular case according to claim 11, wherein a rotatable operating portion of the locking member integrally protrudes on the opposite side of the inclined portion.

15. The tubular case according to claim 12, wherein a rotatable operating portion of the locking member integrally protrudes on the opposite side of the inclined portion.
